(19) United States
(12) Patent Application Publication
(10) Pub. No.: US 2010/0125464 A1
(43) Pub. Date: May 20, 2010

(54) System and Method for Entering a List of Insured Items for Valuation

(76) Inventors: Paul Gross, London, OH (US); Sherry Bangsund, Coon Rapids, MN (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/273,330

(22) Filed: Nov. 18, 2008

(51) Int. Cl. G06Q 40/00; G06F 15/16; G06F 17/30

(52) U.S. Cl. 705/4; 709/206; 707/E17.108

(57) ABSTRACT

The present invention is directed to a system and method for allowing an insured party to directly enter a list of insured items for valuation in connection with an insurance claim. The system includes an application server operating valuation software and an associated web site to allow an insured party to directly enter a list of damaged items in connection with an insurance claim, with the list of items stored in a database for valuation by an insurance carrier or claims administrator. An associated method allows the insured party to directly enter their list of damaged items to a database so that the item list may be retrieved and valuation information added by an insurance carrier or claims administrator.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

In the property insurance industry, the entry, tracking and management of valuation of lists of damaged items in connection with an insured loss have traditionally posed a significant problem for insurance carriers. It is typically cumbersome and very manually intensive for insurance carriers to collect a complete listing of insured items from the insured party and difficult to maintain a compiled list of items that have been valued and/or paid in connection with an insurance claim. Often the policyholder is displaced from their primary residence and therefore difficult to contact through traditional means, particularly following a natural catastrophe. Even when the policyholder is available, capturing the content listing requires utilization of staff and independent Insurance adjusters that often must rely on handwritten lists and notes received from the insured party, those lists may have been copied or faxed to the insurance adjuster resulting in additional effort on the part of the adjuster to read and verify the list of items in order to provide valuation of those items, saddling the insurance carrier with an unreasonable and expensive manual burden, especially when the carrier is inundated with a high volume of claims at one time. In order to efficiently process the lists of items, the insurance carrier and/or a claims administrator must manually enter the items from those received lists into a computer system so that the valuation of those items can be performed. Because the item lists must be transcribed, the process of entering the lists of items is time and labor intensive, resulting in higher costs to the insurance carrier.

### BRIEF SUMMARY OF THE INVENTION

The present invention is directed to a system and method for allowing an insured party to directly enter a list of insured items for valuation in connection with an insurance claim. The system includes an application server operating valuation software and an associated web site, and a valuation database for storing the list of items, attributes, and other valuation data associated with the insured items and provides the insurance carrier and policyholder with the necessary anti-fraud language customized on a state-by-state basis. A method for entering a list of insured items for valuation comprises allowing an insured party to directly enter a list of insured items and associated attributes into a computer accessible valuation database and assigning a replacement value to the items in the list. In another aspect, the method allows for searching the Internet, Web sites, and other computerized databases and catalogs and importing and storing valuation data from those sites into the valuation database server in connection with the items in the list. In yet another aspect, the method provides for reconciling receipts indicating the actual replacement value for the items with the original cost and calculated actual cash value of the items.

### BRIEF DESCRIPTION OF THE DRAWINGS

FIG. 1 shows a block diagram of an exemplary system for entering a list of insured items for valuation in connection with an insurance claim in accordance with an exemplary embodiment of the present invention.

FIG. 2 shows a “screen capture” depiction of a “Login” page of the valuation management web site of the system of FIG. 1.

FIG. 3 shows a “screen capture” depiction of an “Insured Information” page of the valuation management web site of the system of FIG. 1.

FIG. 4 shows a “screen capture” depiction of a “View Claims” page of the valuation management web site of the system of FIG. 1.

FIG. 5 shows a “screen capture” depiction of a “View Orders” page of the valuation management web site of the system of FIG. 1.

FIG. 6 shows a “screen capture” depiction of a “User Management” page of the valuation management web site of the system of FIG. 1.

FIG. 7 shows a “screen capture” depiction of a “New Claim” page of the valuation management web site of the system of FIG. 1.

FIG. 8 shows a “screen capture” depiction of a “Submitted Claim Message” page of the valuation management web site of the system of FIG. 1.

FIG. 9 shows a “screen capture” depiction of a “Disclaimer” page of the valuation management software of the system of FIG. 1.

FIG. 10 shows a “screen capture” depiction of an “Add Items” page of the valuation management web site of the system of FIG. 1.

FIG. 11 shows a “screen capture” depiction of a populated “Add Items” page of the valuation management web site of the system of FIG. 1.

FIG. 12 shows a “screen capture” depiction of a “Content Valuation Report” page of the valuation management web site of the system of FIG. 1.

FIG. 13 shows a “screen capture” depiction of a “Replacement Item” page of the valuation management web site of FIG. 1.

FIG. 14 shows a “screen capture” depiction of an expanded “Replacement Item” page of the valuation management web site of FIG. 1.

FIG. 15 shows a “screen capture” depiction of a populated “Content Valuation Report” page of the valuation management web site of FIG. 1.

FIG. 16 shows a “screen capture” depiction of a “Receipts Summary” page of the valuation management web site of FIG. 1.

### DETAILED DESCRIPTION OF EXEMPLARY EMBODIMENTS OF THE INVENTION

The present invention is directed to a system and method for entering a list of insured items for valuation in connection with an insurance claim. While the invention will be described in detail below with reference to exemplary embodiments, it should be understood that the invention is not limited to the specific system configurations or methodologies of the described embodiments. For example, although the exemplary embodiments are described primarily in the context of a homeowner's insurance claim, the invention could equally be used in connection with other types of insurance claims, such as renter's insurance, automobile insurance, or commercial insurance. In addition, although the exemplary embodiment is described as embodying several different inventive features, one skilled in the art will appreciate that any one of these features could be implemented without the others in accordance with the invention.

### System Configuration of Item Entry and Valuation Web Site

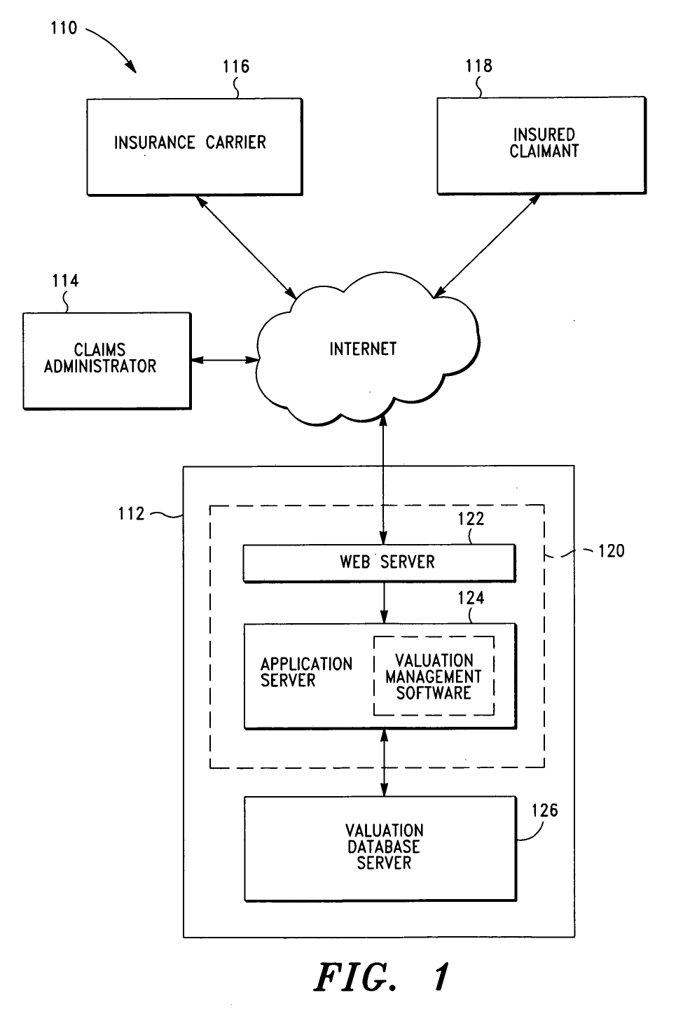

Referring to FIG. 1, an exemplary system for entering a list of items for valuation in connection with an insurance claim in accordance with the present invention is shown generally as reference numeral 110. The system 110 includes an item entry and valuation web site 112 that implements the basic World Wide Web standards for the coding and transmission of hypertext documents. These standards currently include HTML (hypertext mark up language) and HTTP (hypertext transfer protocol). The site 112 is preferably operated by a claims administrator 114 that is responsible for providing the valuation services to an insurance carrier 116. The site 112 is accessible by a plurality of different users (as will be described in more detail below) via the Internet, although other communication networks known in the art could also be used.

Users of the item entry and valuation web site 112 generally include the claims administrator 114 (i.e., the operator of the site), one or more insurance carriers 116 (i.e., the issuers of insurance policies), and one or more insured claimants 118 (i.e., insured parties, typically the owners or occupiers of insured properties). Each of these identified users may include a plurality of individual users. For example, the claims administrator 114 may include claims processors, claims representatives, and claims specialists. An insurance carrier 116 may include insurance adjusters, insurance agents, claims processors, and management personnel. These users are exemplary of the users involved in the valuation of items in connection with a typical insurance claim. Of course, it should be understood that a particular insurance claim may not involve all of these users or may involve users other than those depicted in FIG. 1.

Looking still to FIG. 1, the item entry and valuation web site includes a server system 120 comprising a web server 122 coupled to an application server 124. The web server 112 is connected to the Internet and includes a user interface that presents various web pages to the users, and includes functionality for an insured party to enter and submit a list of items for valuation by entering data describing the items into various data input fields displayed on the web pages (as will be described in greater detail below). Note that while a single application server is depicted in FIG. 1, it should be understood that more application servers may be implemented depending on the number of users accessing the site.

The application server 124 runs a valuation management software application (depicted in phantom lines) that provides capability to the insured party to directly enter a list of items for valuation. As will be described in more detail below, the valuation management software also allows an insurance carrier and/or claims administrator to further process the list of items directly entered by the insured to provide valuation to those items, and capability to manage and administer the web site and database. The application software may be written in any language known in the art, such as Visual Studio C#. One skilled in the art will appreciate that users are able to utilize the capabilities of the valuation management software via the user interface of the web server 112.

The application server 124 is coupled to a valuation database server 126, which stores the list of items entered directly by the insured party and the attributes and other valuation data associated with those items, for each of a plurality of insurance claims. Preferably, the list of items, attributes, and valuation data for the plurality of insurance claims is stored in the valuation database server 126 in association with a claim identifier that is unique to that insurance claim. A variety of different types of attributes and valuation data may be stored in connection with each item, for example, the age of the item, the original cost of the item, and the condition of the item. It should be understood that the server system 120 controls the storage of the entered items, attributes and valuation data in the valuation database server 126. It should also be understood that while a single database server is depicted, the system may comprise more than one database server, may comprise multiple databases controlled by the server, and may include a network of servers and databases that are geographically dispersed.

The valuation site 112 is preferably a secure web site wherein each user is assigned a user identifier (e.g., a user name) and password upon registration with the site 112, or as assigned by a system administrator as described in more detail below. Most preferably, an insured party is issued an encrypted hyperlink to the web site that allows them to access web pages served by the system to directly enter their list of damaged, insured items in connection with an insurance claim. The user identifier and password for each of the users is stored in the valuation database server 126 and defines the data and/or web pages that may be accessed by the user. For example, a claims specialist at the claims administrator may have full access to all of the valuation data and web pages, while an insured claimant may have restricted access only to data entry web pages. Access rights may also be granted or restricted based on permissions defined by the operator of the website, preferably by the claims administrator 114. For example, an insured party may be granted access only to data entry pages to directly enter their list of damaged, insured items, but may not have rights to view all of the valuation data in the database. By contrast, a claims specialist at the claims administrator may be able view all of the valuation data on that same web page.

To gain access to the valuation site 112, a user accesses a login-in page presented by the server system 112 and enters a user identifier and password into appropriate data input fields displayed on the log-in page, or, most preferably, an insured party accesses the system using an encrypted link to that page provided by the claims administrator as described in more detail below. The server system 112 authenticates the user identifier and password (i.e., verifies that the user identifier and password are stored in the valuation database server 126) and determines the access rights for the user. The user is then able to access various web pages of the site 112 in accordance with the access rights for that user.

### Methodology of Entering a List of Items for Valuation

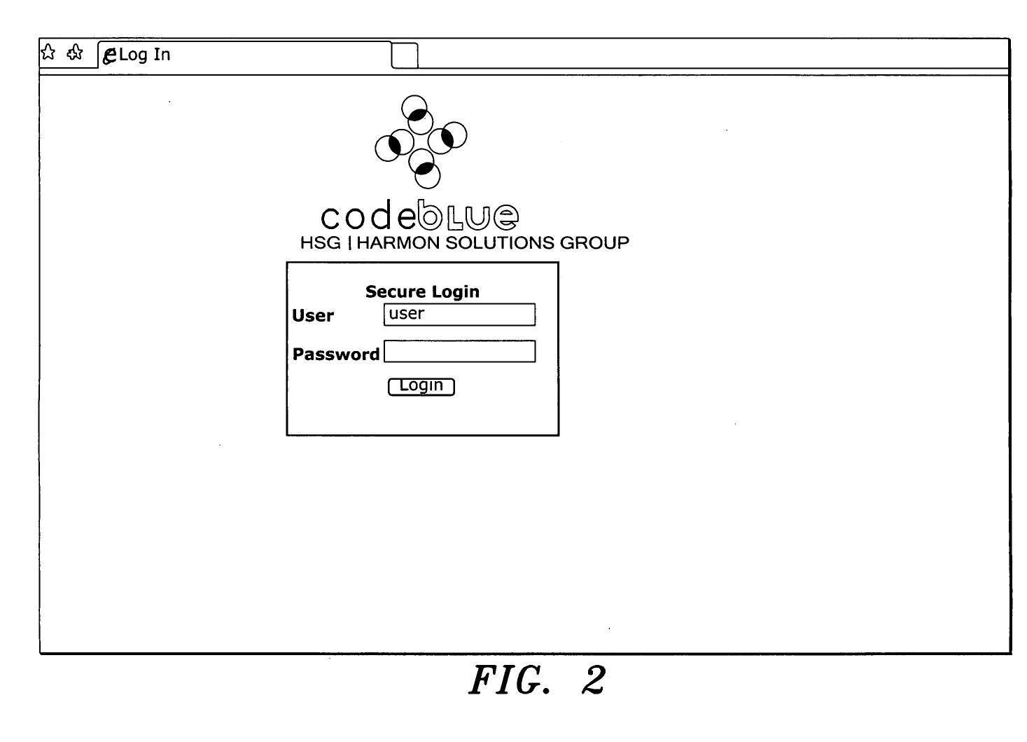

An exemplary method for entering a list of insured items for valuation in connection with an insurance claim in accordance with an exemplary embodiment of the present invention will now be described with reference to the system of FIG. 1 as just described and the web page “screen captures” depicted in FIGS. 2-18. As can be seen, each of these web pages displays a variety of data input fields, selection buttons, hyperlinks and various textual information. It should be understood that the web pages shown in FIGS. 2-18 are merely examples of the type of web pages that may be used to implement the various features of the invention. Other web pages could be used that display the claim data in a different format and/or that display different types of claim data. For example all of the valuation data could be displayed on a single web page, or the information on different pages could be combined in varying ways. As such, throughout the following description (including in the claims), the terms “web pages” and “web page” are used interchangeably to refer to either a single web page or a plurality of web pages that collectively display a variety of different types of claim data.

Furthermore, while the valuation process will be described with respect to this exemplary embodiment and in an order typical for an insured party making a claim and directly entering a list of insured items for valuation, it will be understood that variations in the order in which information is entered, variations in the specific information indicated on the web pages, and variations in the order in which the web pages are accessed are all within the scope of the present invention.

The valuation process typically begins with an insured party (i.e., insured claimant 118) contacting their insurance carrier 116 or a claims administrator 114 (engaged by the insurance carrier) to report damage or loss to insured items. Typically, the insured party initiates contact via telephone, although the contact and subsequent correspondence may also be via mail, email, or other communication methods known in the art. The contact person may be an insurance agent, insurance adjuster or other claims representative who collects basic information from the insured party, including their name, address, telephone number, insurance policy number, and date of loss. Note that the term “claims representative” as used herein denotes the contact person at the insurance carrier, the claims administrator, or any other person authorized by the insurance carrier to handle the claim.

Upon initial contact by the insured party, the claims representative accesses the valuation application through the “Login” page depicted in FIG. 2, entering their user name and password. That entered information is compared to the account and access information stored on the valuation database server as described above. As is known in the art, a systems administrator setting up accounts can permit or deny access to various pages and aspects of the valuation software and database. For example, a switchboard operator at the insurance carrier may be granted view-only access to general claims information, while an insurance adjuster may be granted full edit and delete privileges, with access to all claim information.

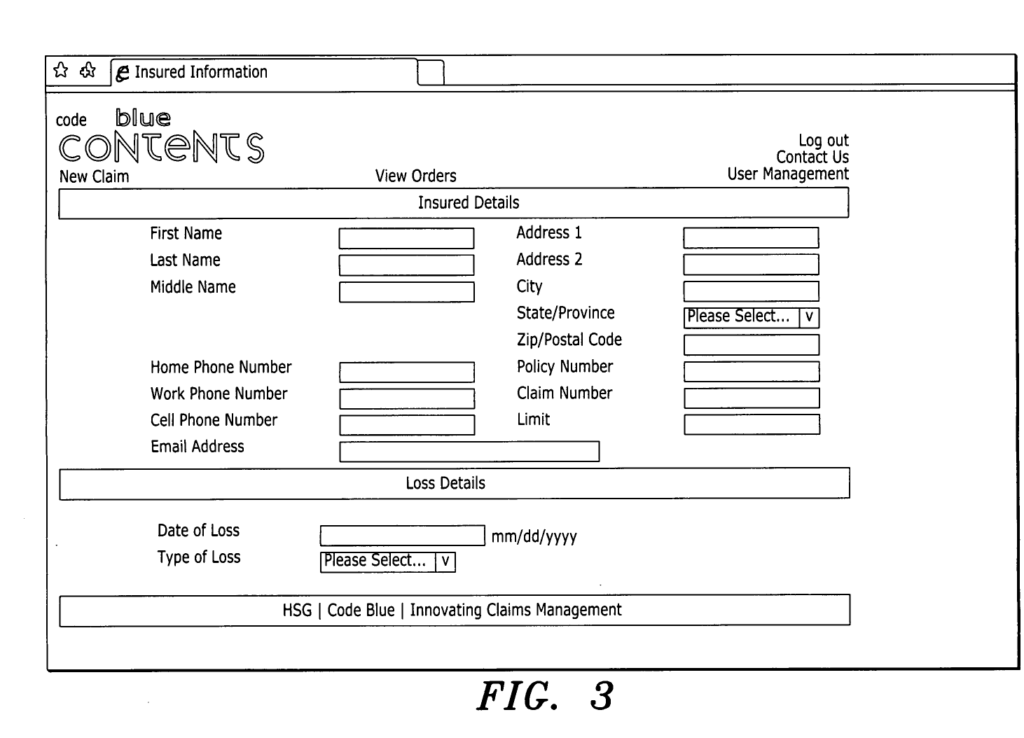

After logging in to the item entry and valuation web site, the claims representative is presented with the “Insured Details” page as depicted in FIG. 3. Across the top of the page are hyperlinks for “New Claim”, “View Orders”, “Log Out”, “Contact Us”, and “User Management” that allow the claims representative to quickly navigate to various areas of the valuation application web site. Note that similar hyperlinks appear on other web pages throughout the application to allow easy navigation between the pages. As will be described in more detail below, the “New Claim” and “View Orders” links allow the claims representative to set up a new claim and view existing claims, respectively. The “User Management” link takes the claims representative to a screen where the valuation system can be managed—e.g., new users can be added or access privileges modified. Typically the “User Management” feature will only be available to a user having system administrator rights. The “Contact Us” link provides for a user to contact the claims administrator responsible for operating the web site, and the “Log Out” link signs the user out of the valuation application and web site.

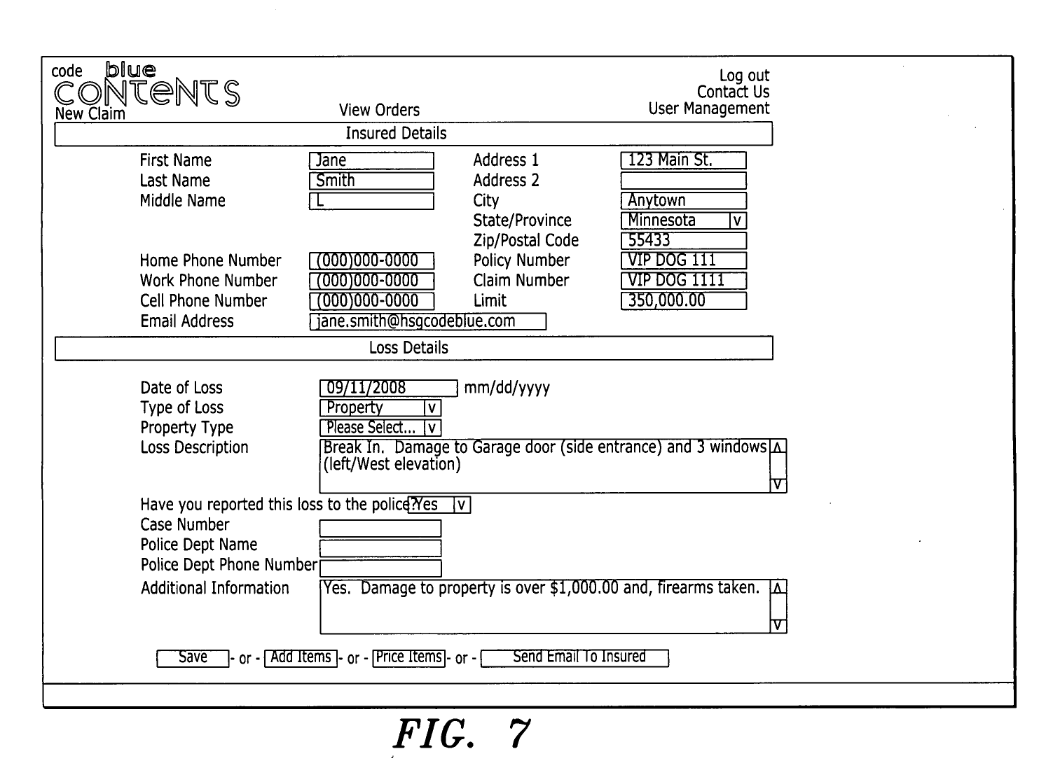

Continuing with the description of an exemplary claim, the claims representative in contact with insured party selects the “New Claim” hyperlink on the page of FIG. 3, and is presented with the “New Claim” page as shown in FIG. 7. As information is collected from the insured party, the claims representative enters that information into the data entry fields on the page. Information collected includes: first name, last name, middle name, address, city, state, zip code, home phone number, cell phone number, work phone number, cell phone number, insurance policy number, claim number, and coverage limit. If any of the information is not known or is not applicable, the claims representative may leave the particular field blank and/or may fill in the information later. The “claim number” is a unique claim identifier associated with the claim information that may be automatically generated by the valuation application itself, or may be an identifier assigned by the insurance company and manually entered into the field.

Looking still to FIG. 7, in the “Loss Details” portion of the page, the claims representative enters the date of loss, the type of loss (selected from a pull-down menu), the property type (selected from a pull-down menu), a narrative description of the loss, any police report information, and any additional information offered by the insured party or considered useful by the claims representative. The claims administrator presses the “Save” button at the bottom of the screen to cause the valuation application to save the entered information to the valuation database server.

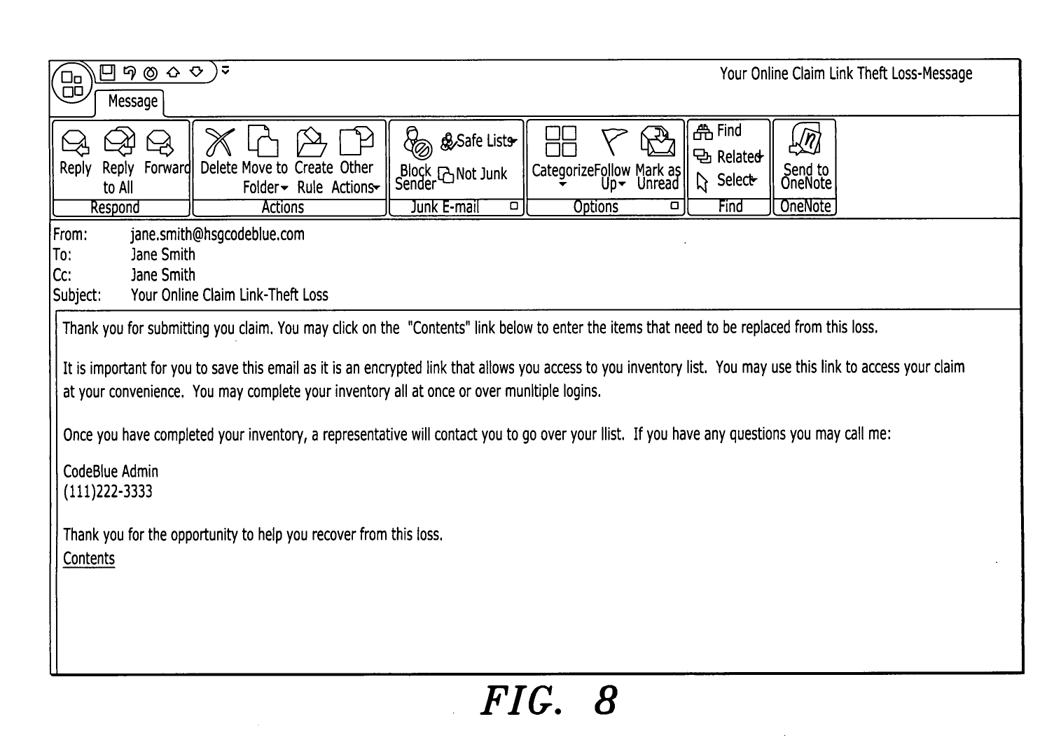

Next, using the “Send Email to Insured” option, the valuation software generates and sends an email to the insured party as depicted in FIG. 8. The email explains that the claim has been opened, and includes an encrypted hyperlink, labeled “Contents” in the exemplary page depicted. The encrypted hyperlink includes both a navigation component (to provide a path to a web page that will allow the insured party to directly enter a list of damaged items in connection with the insurance claim), and an authentication component (to provide the authentication information, i.e., a username and password, that allows access to the web page).

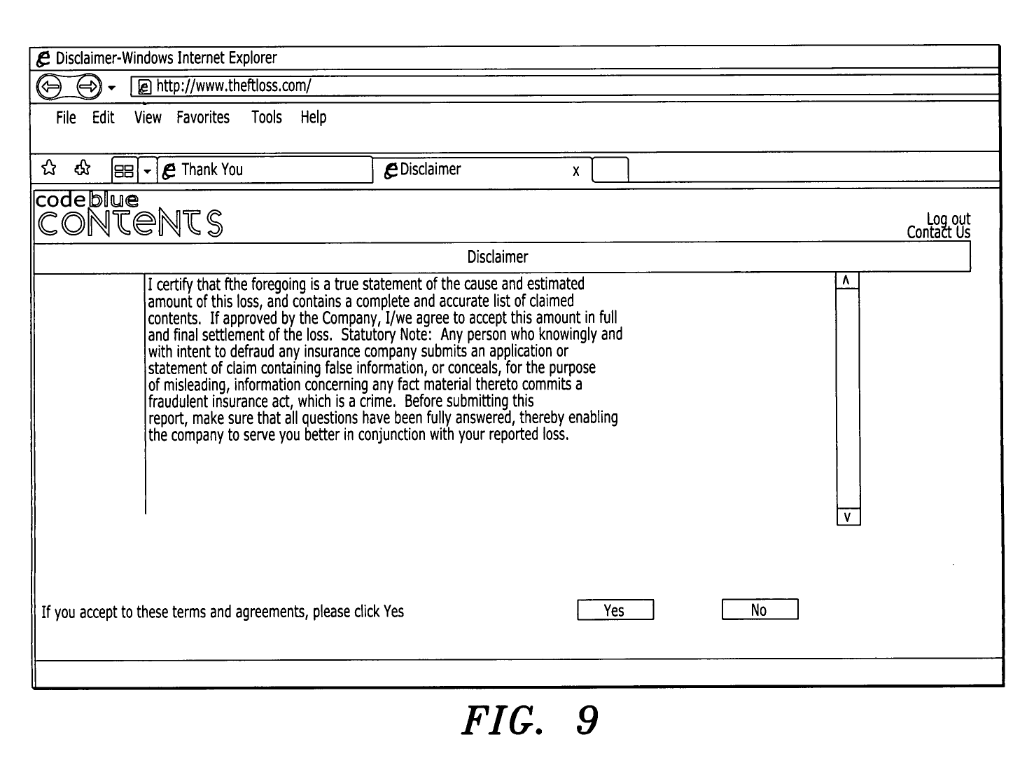

In addition to the email containing the hyperlink, the valuation application generates and sends a “Disclaimer” email to the insured as depicted in FIG. 9. The disclaimer email includes state-specific notices related to the claim and allows the insured party to accept (“Yes” button) or decline (“No” button) the statements and declarations made in the email. The valuation application generates the disclaimer based on information stored on the valuation database server specific to the state where the loss occurred, and/or specific to the state where the insured party resides. Preferably, the insured party will not be allowed access to the item entry and valuation web site through the encrypted link until the insured party accepts the terms of the disclaimer.

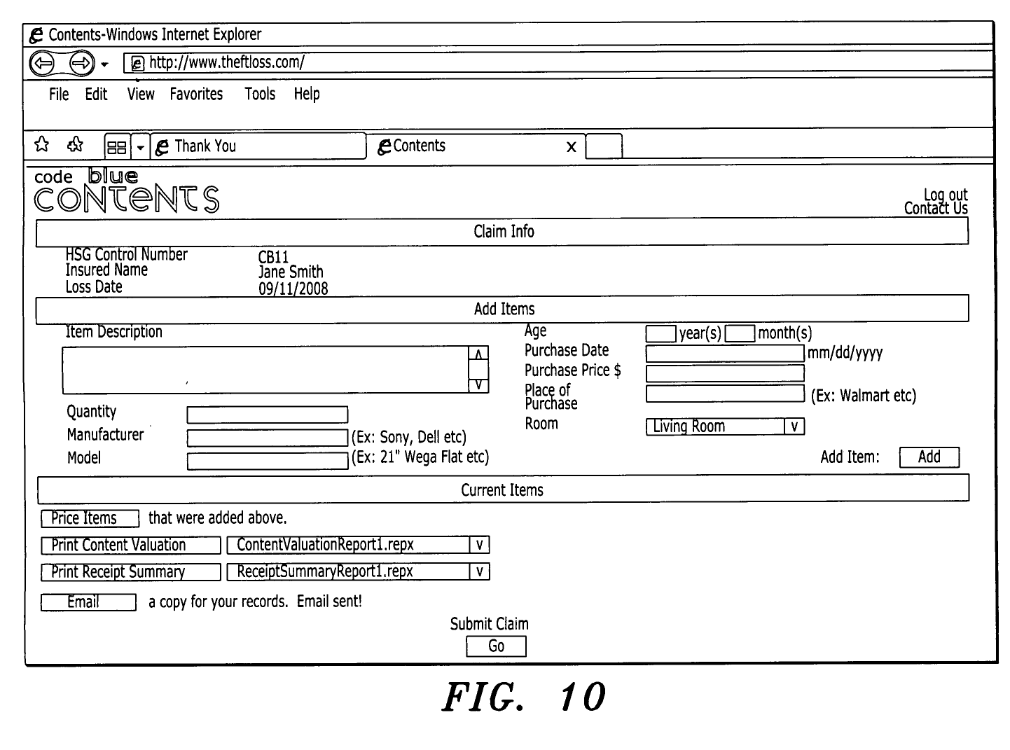

Having accepted the disclaimer, by clicking on the encrypted link provided in the email, the insured party is directed to an “item entry” web page as depicted in FIG. 10. As shown in that figure, the page includes a “Claim Info” section where the insured's name and loss date are automatically populated from the information previously entered and stored in the valuation database in association with the claim. The field labeled “HSG Control Number” may be the unique claim identifier associated with the claim as described above, or any other tracking number associated with the claim, preferably assigned by the claims administrator. Using the date entry boxes on the page, the insured party directly enters a description for a damaged item, a quantity of that item, a manufacturer and model number for the item, the age, purchase date, purchase price, place of purchase, and room (i.e., location of damaged item in the insured property). Of course, not all information may be known for any particular item in which case the fields can be left blank. The “Age” and “Purchase Date” fields work in conjunction such that entering information into either one of those fields will cause the other field value to be calculated and populated by the valuation application. Once all of the known information for an item is entered, the insured party presses the “Add” button located at the mid-lower right portion of the page to cause the valuation application to store that information in the valuation database.

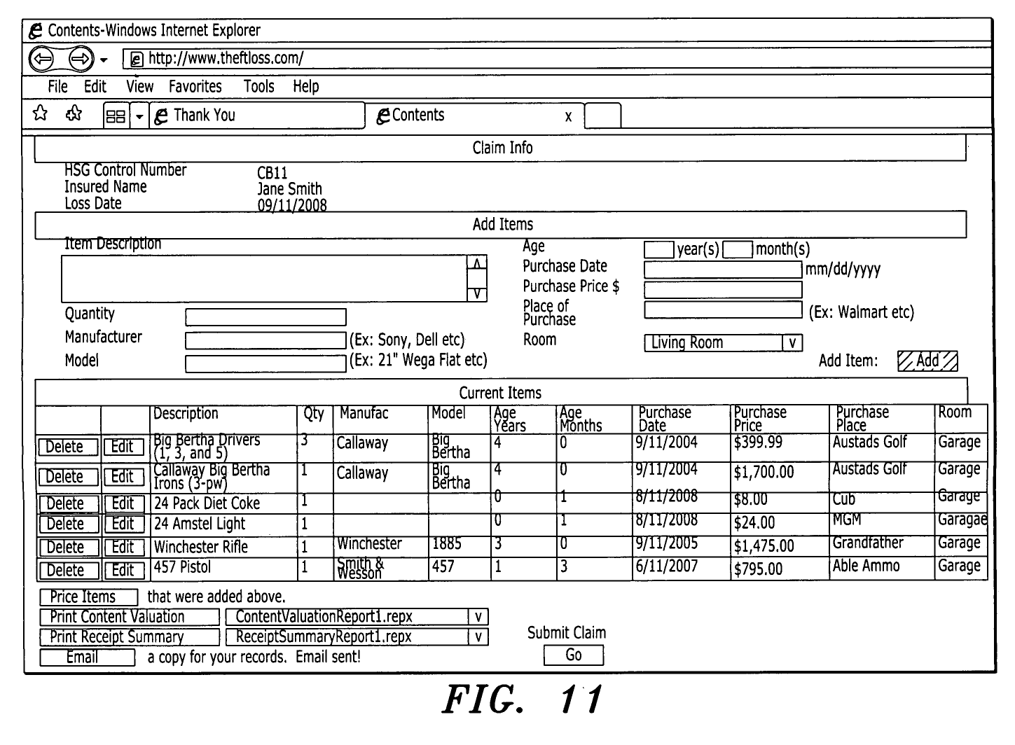

Looking to FIG. 11, as items are added to the list, those items and the information associated with those items are populated into the “Current Items” section of the “Add Items” page. Each listed item also includes an associated “Delete” and “Edit” button to allow the insured party to delete an added item or to modify the existing information for an item. Thus, using the item entry screen the insured party can directly enter a list of damaged (or lost, or otherwise eligible for insurance coverage) items into the system, with the valuation application storing the list of items and associated attributes and valuation information in the valuation database. The insured party can continue entering their list of items as just described using the “Add” button, with each item added appearing in the “Current Items” list at the bottom of the page. If any items are erroneously added, they can be removed using the “Delete” button associated with that listed item. Similarly, information for any item in the list can be changed using the “Edit” button associated with that item. Thus, an insured party using the system can enter their entire list of damaged items into the valuation database without assistance from the insurance carrier or the claims administrator.

Once the insured party has completed entry of their list of items and the valuation application has saved the item list and corresponding attribute information to the valuation database, the insured party can select the “Print Content Valuation”, “Email” or Submit Claims “Go” buttons located along the bottom of the page.

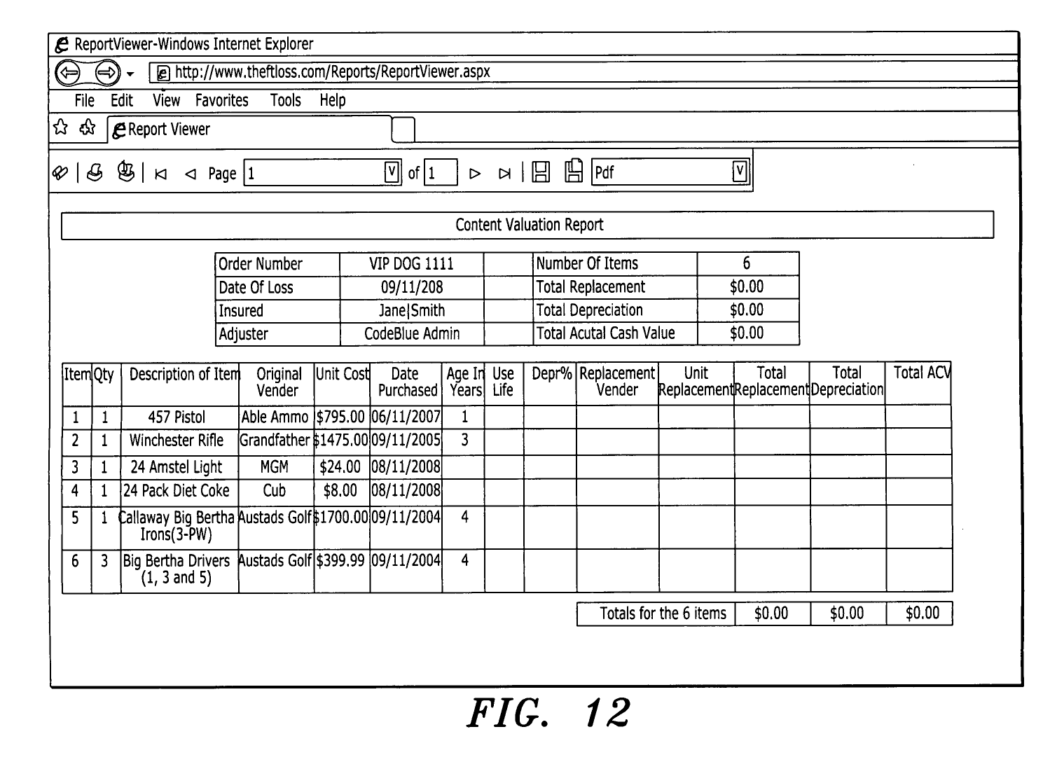

Selecting the “Print Content Valuation” button and entering or selecting a report name from the associated drop-down menu takes the user to the “Content Valuation Report” page as shown in FIG. 12. As seen in FIG. 12, the content valuation report enumerates and lists the damaged items list previously entered and the information and attributes associated with that item, along with information relating to the valuation and replacement cost of that item, as will be described in more detail below. Using the drop-down menu at the upper right portion of the report, the report can be exported to an electronic file in various formats, such as Microsoft Excel®, .pdf, .mht, .rtf, and other formats known in the art.

Similar to selecting the “Content Valuation Report” button as just described, selecting the “Email” button causes the valuation application to send an electronic copy of the content valuation report via email to the insured party for their records.

When the insured party has completed entering their item list and printed or emailed a copy of the content valuation report for their records, selecting the “submit claim” “Go” button as shown in FIG. 11 causes the valuation application to notify the claims administrator and/or insurance carrier that the insured party has directly entered their list of damaged items, indicating that the item list is stored in the valuation database for further procession and valuation.

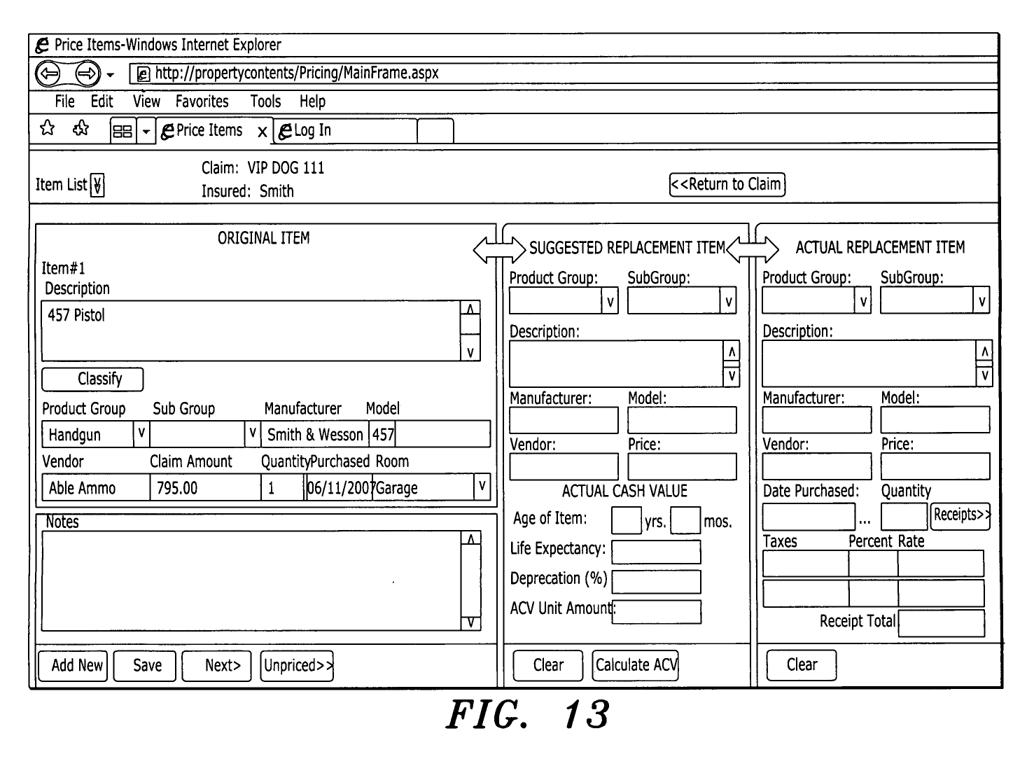

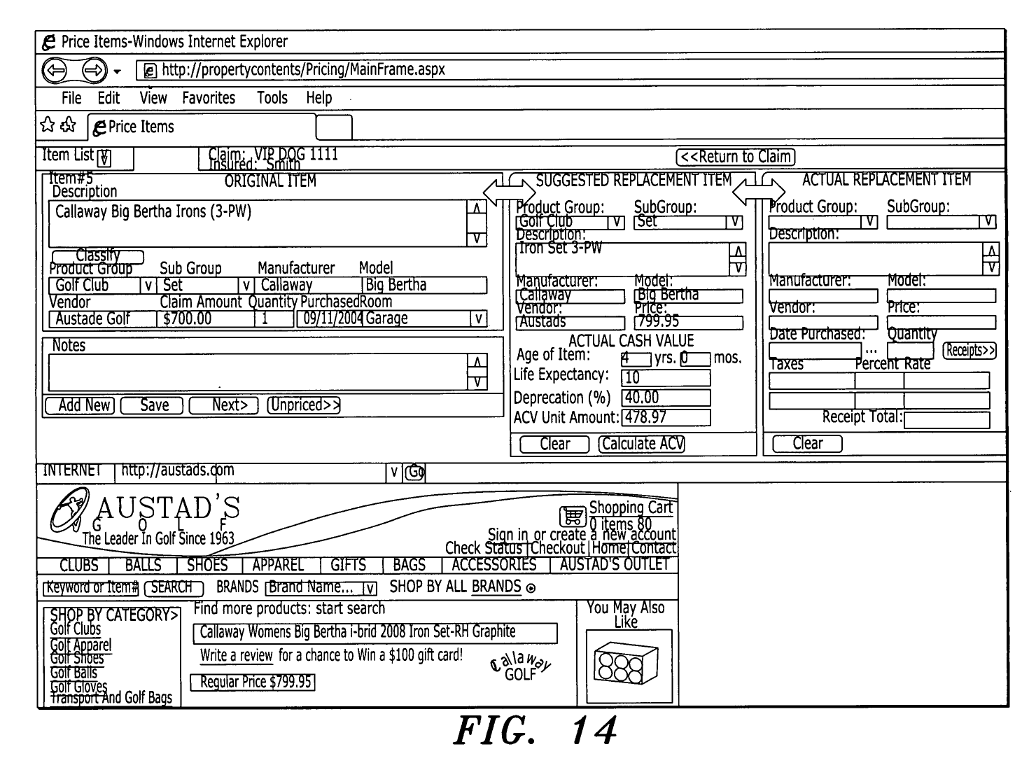

Upon receipt of notification that the insured party has directly entered their list of damaged items, the claims administrator may access the system and review the list of items and begin entering valuation information for the items in the list as will now be described. Selecting the “Price Items” button as shown in FIG. 11 allows a claims representative (e.g., an insurance adjuster, claims administrator, or insurance carrier) to access the “Price Item” pages as shown in FIGS. 13 and 14.

Looking first to FIG. 13, the “Item List” drop-down menu allows the user to select any of the items previously entered into the item list for valuation. Selecting an item causes the valuation application to populate the “Original Item” window with the item's information as previously entered. The “Suggested Replacement Item” window allows the claims representative to enter a comparable or identical suggested replacement item long with a product group and subgroup classification (for purposed of determining the depreciation schedule for the item) selected from drop-down menus, and an item description, manufacturer, model, vendor, and price. The suggested replacement item information may be entered manually (or as described in more detail below, imported from a Web site, the Internet, or other computer database or catalog) by the claims administrator based on their knowledge and/or on other pricing information. When an original item includes an age or purchase date, the “Actual Cash Value” fields of the “Suggested Replacement Item” window are populated with that information, and pressing the “Calculate ACV” button causes the valuation application to calculate a life expectancy, depreciation amount, and ACV amount based on the replacement price, age, and product group/subgroup information.

When an insured party has provided information regarding actual replacement of the item (i.e., a receipt), then the claims administrator fills in the information in the “Actual Replacement Item” window with the replacement item information. That receipt information is used by the valuation application to calculate any additional payment due to the insured party (typically the difference between the depreciated value initially calculated and paid by the insurance carrier and the actual replacement price of the item). The receipt information is also used and displayed in the “Receipts Summary” report as will be described below.

Looking to FIG. 14, the “Price Item” page can be configured to include a lower window running a web browser, or otherwise operable to access the Internet, a Web site, or other database or catalog of pricing information. In the exemplary embodiment shown in FIG. 14, based on information for the item listed in the “Original Item” window, the user has directed a web browser operating in the lower window to a manufacturer's web site selling comparable replacement items. When the user has located a comparable item and has it displayed in the lower window, that information can be entered into the fields of the “Suggested Replacement Item” window as previously described. Preferably, the valuation application can automatically populate the information from the lower window into the suggested replacement item window by pressing a button on the web page of FIG. 14, causing the valuation application to capture the information in the lower window via parsing and/or scraping technology to extract the information for the replacement item corresponding to the fields in the suggested replacement item window.

Thus, a claims representative can navigate through the items list using the drop-down menu to select each item, navigate through web pages, web catalogs, or other databases to locate comparable replacement items, populate that information into the “Suggested Replacement Item” window fields, and calculate the actual cash value (ACV) of the item at the press of a button. And, as described previously, information from the receipts of actual replacement items purchased by the insured party can be entered into the “Actual Replacement Item” window.

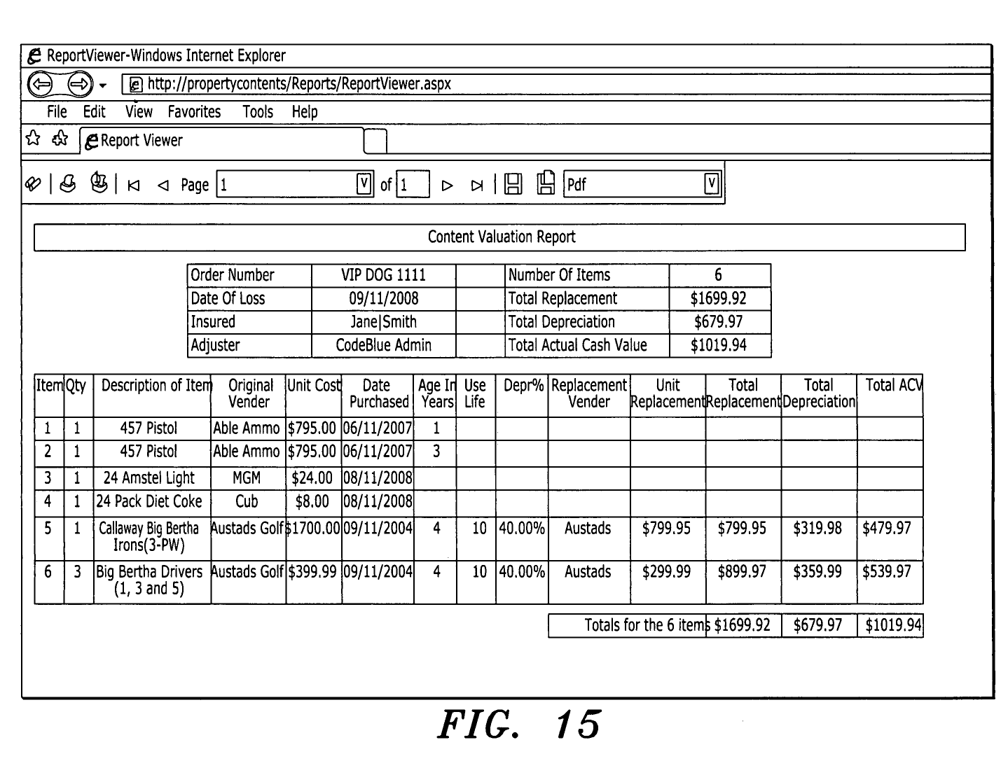

Looking to FIG. 15, with the replacement item information entered and stored in the database as just described, the “Content Valuation Report” (described previously) is also populated with the additional information regarding the age, replacement value, and depreciation of the items in the list. Thus, as can be seen, the information entered into the various web pages of the valuation application is stored in the valuation database and accessible to the other web pages of the application so that the information and attributes associated with each individual item aggregate and build upon each other so that each web page is continually updated with all of the available information

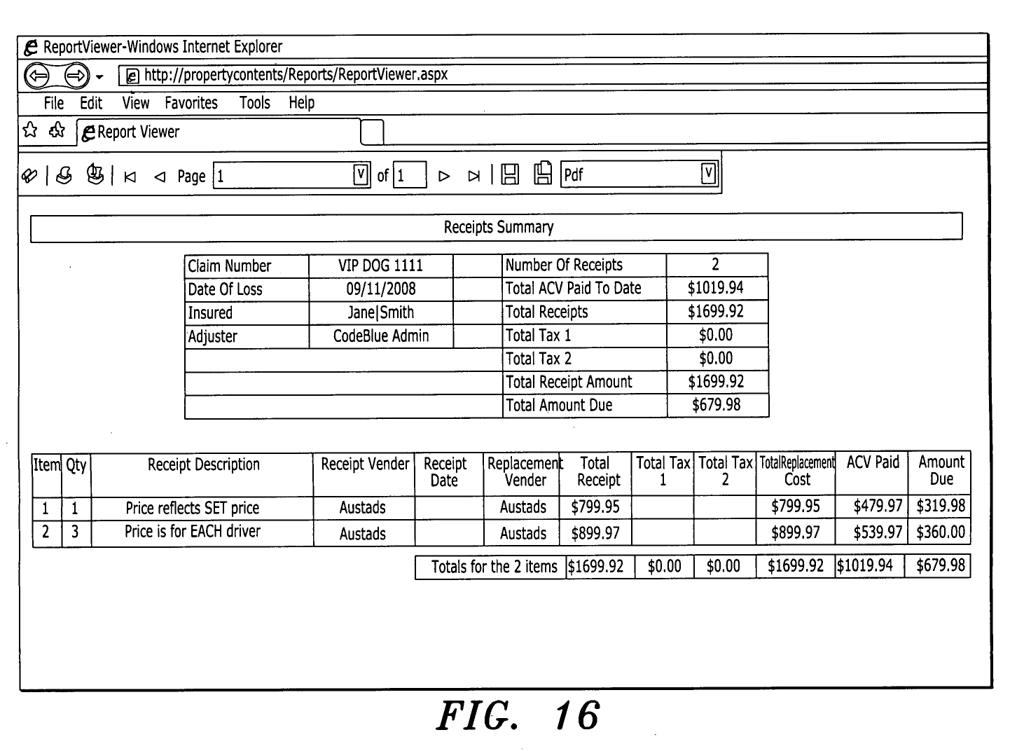

In a manner similar to that described for the “Print Content Valuation” button, selecting the “Print Receipt Summary” button shown in FIG. 11 and entering or selecting a report name from the associated drop-down menu takes the user to the “Receipts Summary” page as shown in FIG. 16. As seen in FIG. 16, the receipts summary report enumerates and lists any receipts and associated information relating to actual replacement of any of the items previously entered. The receipts summary report lists the replacement cost (i.e., receipt value) for any item, the actual cash value (ACV) already paid, and any amount due to the insured party for that item. For example, looking to FIG. 16, the receipts summary report includes claim information pre-populated into the fields in the center left of the page, with receipt information and totals displayed in the fields on the center right of the page, with an individual listing for each receipt at the bottom of the page.

Because the system and method of the present invention contemplate handling numerous claims for numerous insurance carriers, each claim itself comprising a list of items directly entered by the insured party, the system and method also provide for administrative web pages for viewing and otherwise managing those claims.

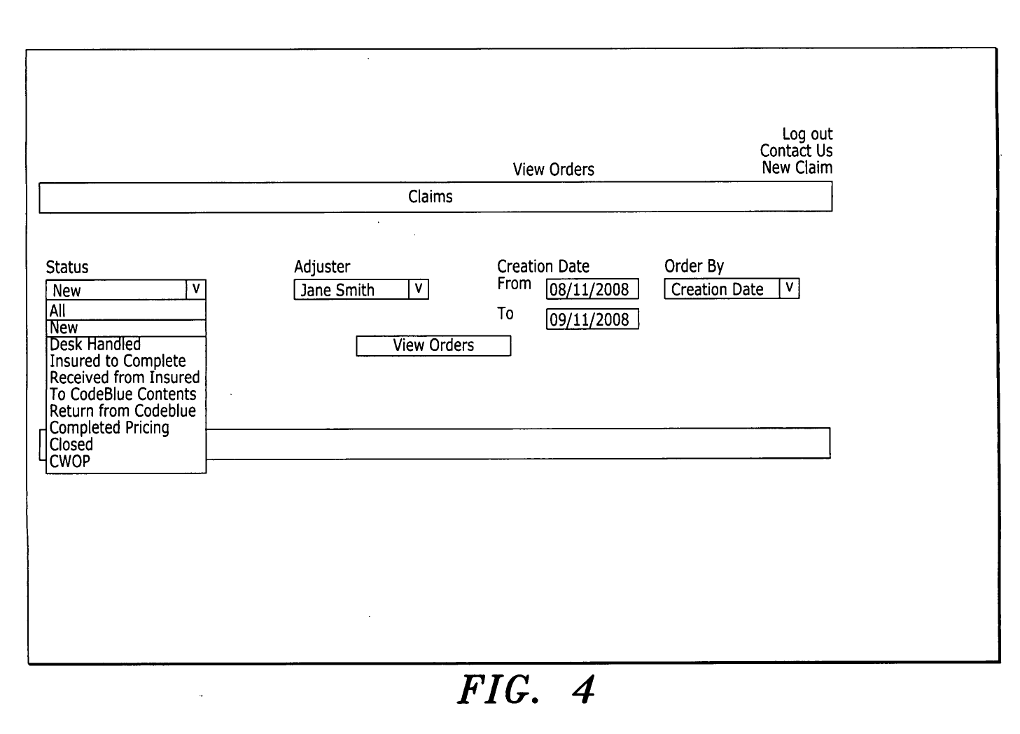

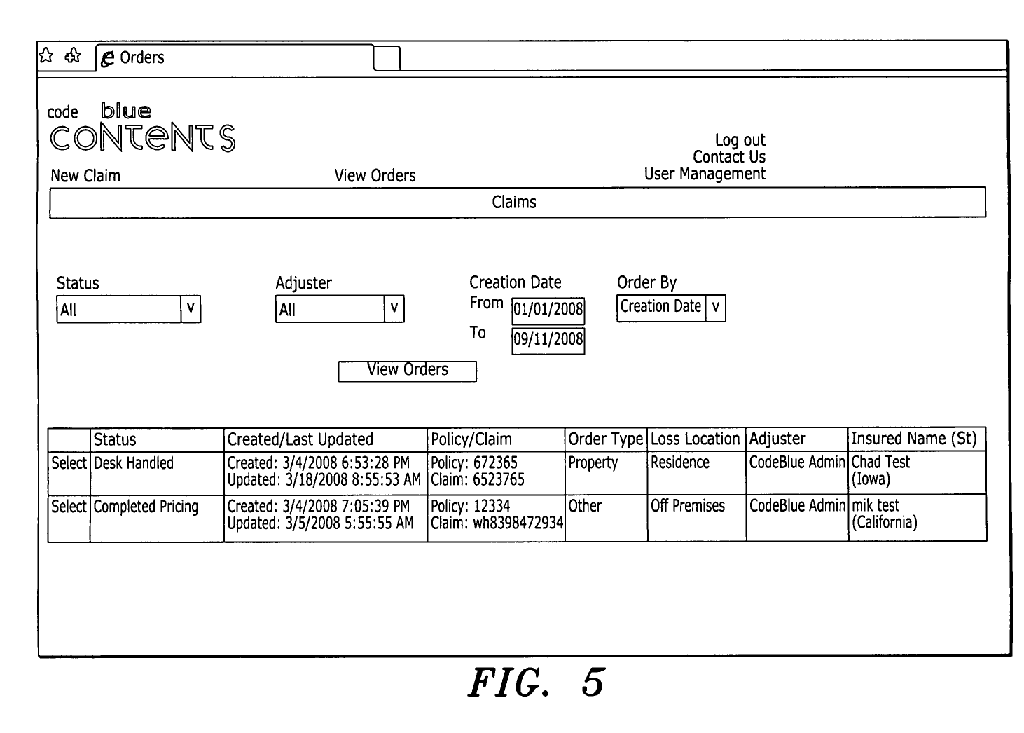

Looking to FIGS. 4 and 5 web pages for searching for and viewing claims are depicted. Using the page of FIG. 4, a claims representative can select to search for claims by the status of the claims (new, desk handled, insured to complete, received from insured, to CodeBlue contents (i.e., the claims administrator), return from CodeBlue, completed pricing, closed, and closed without payment (CWOP)), by the adjuster handling the claim, by a range of creation dates. The claims representative is also given a pull-down menu to select the order in which the claims matching the search criteria will appear. Upon pressing the “View Orders” button, the valuation application searches the valuation database and locates claim records matching the selected search criteria, and presenting the located records in a table at the bottom of the page as shown in FIG. 5. The table is populated with the information stored in the database and ordered in the order selected on the page as described above.

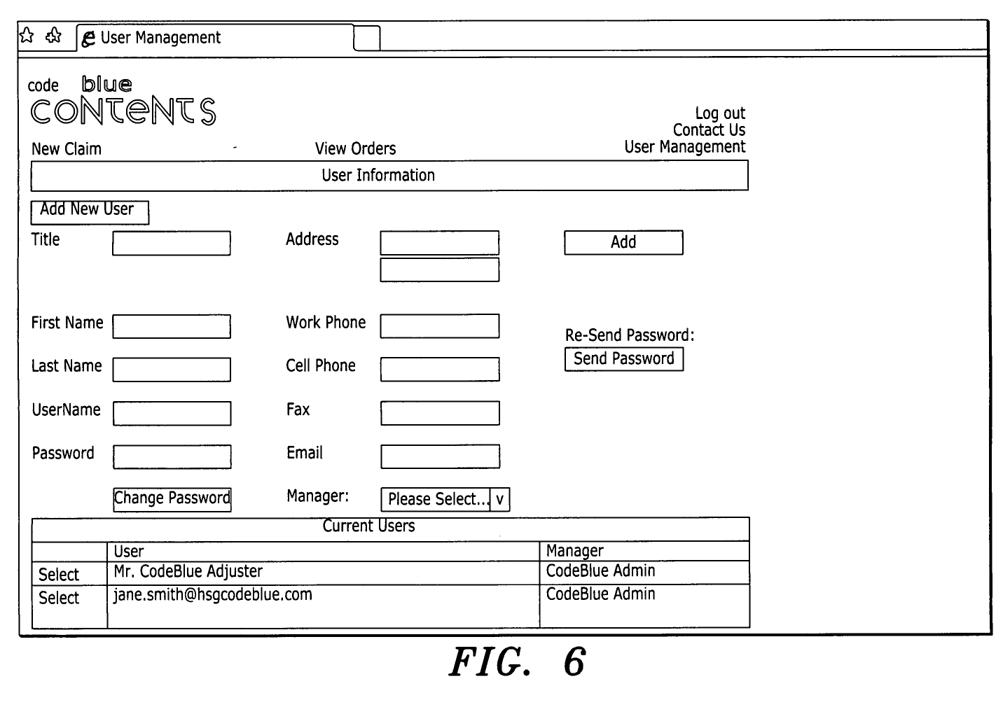

Looking to FIG. 6, the “User Management” page allows a system administrator (i.e., a claims administrator or insurance carrier authorized user) to add new users to the system. For example, the system administrator may add new insurance adjusters, claim representatives, or any other authorized user to the system. Even an insured party be set-up as a user of the system to allow that insured party to access the system and enter items for valuation, or that insured party may use only the encrypted link method of access as described previously.

Still looking to FIG. 6, to set up a new user, the system administrator enters the new user's “Title”, “First Name”, “Last Name”, “Address”, “Work Phone”, “Cell Phone”, “Fax”, and “Email” information. A “Manager” for the account, such as a claims adjuster or claims administrator is chosen from the drop-down menu. Finally, a “Password” is assigned to the user. With the information entered, pressing the “Add” button stores the information to the valuation database server. The valuation application then uses that stored information to allow a user having that username and password to access the system.

The “Send Password” button allows the system administrator to send or re-send the users password to the email address on record (e.g., if the user forgets their password), and the “Change Password” button allows the system administrator to change the password for the user. A listing of “Current Users” at the bottom of the page presents a list of already-defined users, selecting a user from that list will populate the data fields on the page with the information associated with that user. Thus, a system administrator can easily pull-up existing information for users in order to modify or re-send information.

As can be seen, the system and method described herein are well suited to allow an insured party to directly enter a list of damaged items in connection with an insurance claim so that those items can be valued for reimbursement by an insurance carrier. While the system and method herein have been described in association with exemplary web pages, it is understood that variations from the pages as shown can be implemented, and arc within the scope of the present invention. For example, while the web pages shown are depicted as being associated with a particular claims administrator, the pages can be branded to conform to any particular insurance carrier or claims administrator, or can be customized to display particular information based on the particular user name accessing the system.

Other advantages of the exemplary system and method presented herein are contemplated by the present invention. For example, the aggregation of information for items and associated attributes and valuation information stored on the valuation database server allows that data to be examined or mined to determine any number of statistics related to the data. For example, an insurance carrier could query the data to determine the most commonly claimed item, or to determine the item most commonly over-valued by an insured party. The data can also provide statistics related to a particular insurance adjuster, to a particular region of the country, or to any combinations or subcategories of data. These and other uses of the data are contemplated by the present invention.

While the present invention has been described and illustrated hereinabove with reference to an exemplary embodiment and exemplary, it should be understood that various modifications could be made to the embodiments described without departing from the scope of the invention. Therefore, the invention is not to be limited to the specific embodiment described and illustrated hereinabove, except insofar as such limitations are included in the following claims.

What is claimed and desired to be secured by Letters Patent is as follows:

1. A method for entering a list of insured items for valuation in connection with an insurance claim, comprising:
providing a valuation computer system operable to allow entering and storing to a database a list of insured items and attributes associated with said items;
allowing an insured party to access said valuation computer system such that said insured party directly enters said list of insured items into said valuation computer system; and
assigning a value to said items in accordance with said attributes associated with said items.

2. The method of claim 1, wherein said valuation computer system comprises a web site server and a database server, said web site server operable to provide a user interface comprising web pages to said insured party, and said database server operable to store said list of insured items and attributes to said database.

3. The method of claim 2, wherein said web site server is operably connected to the Internet and wherein said insured party accesses said valuation computer system through the Internet.

4. The method of claim 1, wherein said allowing an insured party to access said valuation computer system comprises providing said insured party with an encrypted hyperlink providing direct navigation to a web page provided by said web site server.

5. The method of claim 1, wherein said allowing an insured party to access said valuation computer system comprises providing said insured party with a username and password operable to allow access to said valuation computer system.

6. The method of claim 1, wherein said attributes comprise an age, an original price, a purchase date, and combinations thereof.

7. The method of claim 1, further comprising:
printing a content valuation report comprising a listing of said list of items.

8. The method of claim 7, wherein said listing comprises at least one of said attributes.

9. The method of claim 1, further comprising:
mailing to said insured party a report comprising a listing of said list of items.

10. The method of claim 1, further comprising transmitting a state-specific notice to said insured party.

11. The method of claim 1, wherein said valuation computer system is operably connected to computer network selected from the group comprising private networks, the Internet, the World Wide Web, and combinations thereof.

12. The method of claim 1, further comprising:
searching a product database for items comparable to at least one of said insured items;
calculating a replacement value for said at least one of said insured items; and
assigning said replacement value to said at least one of said insured items.

13. The method of claim 12, further comprising:
determining an actual replacement value for said at least one of said insured items; and
providing a reconciliation report comparing said actual replacement value to said calculated replacement value.

14. A method for directly entering a list of insured items for valuation in connection with an insurance claim, comprising:
providing a valuation computer system operable to allow entering and storing to a database a list of insured items and attributes associated with said items, said valuation computer system further operable to serve web pages allowing entry of item information and attributes;
transmitting to an insured party an encrypted hyperlink operable to direct said insured party's web browser to access said valuation computer system web pages;
allowing said insured party to directly enter said list of items into said web pages; and
storing said directly entered list of items to a valuation database.

15. The method of claim 14, further comprising:
assigning a value to said items in accordance with said attributes associated with said items.

16. The method of claim 14, wherein said valuation computer system is operably connected to the Internet and wherein said insured party accesses said valuation computer system through the Internet.

17. The method of claim 14, wherein said attributes comprise an age, an original price, a purchase date, and combinations thereof.

18. The method of claim 14, further comprising:
printing a content valuation report comprising a listing of said list of items.

19. A system for directly entering a list of insured items for valuation in connection with all insurance claim, comprising:
a database server;
a server system coupled to said database server, wherein the server system is operable to:
provide a user interface operable to present one or more web pages that include functionality for an insured party to directly enter a list of insured items and associated attributes for valuation in connection with an insurance claim; and
store said entered list of insured items and attributes in said database server in association with a claim identifier.

20. The system of claim 19, wherein said server system is further operable to:
transmit to said insured party an encrypted link operable to direct a web browser of said insured party to said web pages and allow access to said web pages such that said insured party can directly enter said list of insured items into said web pages.

21. The system of claim 19, wherein said server system is further operable to provide a valuation report presenting an aggregated value of said list of insured items.
